(19) United States
(12) Patent Application Publication
(10) Pub. No.: US 2013/0172195 A1
(43) Pub. Date: Jul. 4, 2013

(54) OPTICAL DETECTORS AND ASSOCIATED SYSTEMS AND METHODS

(71) Applicants: Francesco Bellei, Cambridge, MA (US); Karl K. Berggren, Arlington, MA (US); Eric Dauler, Charlestown, MA (US); Xiaolong Hu, New York, NY (US); Francesco Marsili, Boulder, CO (US); Faraz Najafi, Cambridge, MA (US)

(72) Inventors: Francesco Bellei, Cambridge, MA (US); Karl K. Berggren, Arlington, MA (US); Eric Dauler, Charlestown, MA (US); Xiaolong Hu, New York, NY (US); Francesco Marsili, Boulder, CO (US); Faraz Najafi, Cambridge, MA (US)

(73) Assignee: Massachusetts Institute of Technology, Cambridge, MA (US)

(21) Appl. No.: 13/633,666

(22) Filed: Oct. 2, 2012

Related U.S. Application Data
(60) Provisional application No. 61/543,875, filed on Oct. 6, 2011.

(51) Int. Cl. G01J 1/42; G01J 1/04; G01J 5/08; G01J 5/10

(52) U.S. Cl. CPC G01J 1/42; G01J 5/10; G01J 1/0411; G01J 5/0806; Y10S 977/954; B82Y 20/00
USPC 505/160; 250/200; 250/338.1; 250/216; 250/353; 977/954

(57) ABSTRACT

Optical detectors and associated systems and methods are generally described. In certain embodiments, the optical detectors comprise nanowire-based single-photon detectors, including those with advantageous geometric configurations.

### RELATED APPLICATIONS

This application claims priority under 35 U.S.C. §119(e) to U.S. Provisional Patent Application Ser. No. 61/543,875, filed Oct. 6, 2011, and entitled “Cavity-Integrated Ultra-Narrow Nanowire-Width Superconducting Nanowire Single-Photon Detector Based on a Thick Niobium Nitride Film,” which is incorporated herein by reference in its entirety for all purposes.

### GOVERNMENT SPONSORSHIP

This invention was made with government support under Contract No. HR001-10-C-0159 awarded by the Defense Advanced Research Projects Agency and under Contract No. FA8721-05-C-0002 awarded by the U.S. Air Force. The government has certain rights in the invention.

### TECHNICAL FIELD

Optical detectors, including single-photon detectors, and associated systems and methods are generally described.

### BACKGROUND

The use of nanowires in single-photon detectors is a burgeoning field of research. In many traditional nanowire-based detectors, one or more nanowires are positioned on a substrate toward which photons are directed. Upon reaching the detector, individual photons can couple with the nanowire(s) upon contact, producing a detectable signal. While detectors exhibiting sub-40-picosecond timing jitter and sub-2-nanosecond reset times have been developed, the detection efficiencies of many such detectors have been limited. In some cases, single-photon detectors have been integrated with plasmonic antennas or optical waveguides to increase detection efficiency. However, such structures can be challenging to fabricate, as they require precise alignment with the detector. Improved methods for increasing the efficiencies of single-photon detectors are therefore desirable.

### SUMMARY

Optical detectors and associated systems and methods are generally described. In certain embodiments, the optical detectors comprise nanowire-based optical detectors, including those with advantageous geometric configurations. The subject matter of the present invention involves, in some cases, interrelated products, alternative solutions to a particular problem, and/or a plurality of different uses of one or more systems and/or articles.

In one aspect, an optical detector is provided. The optical detector comprises, in certain embodiments, a nanowire comprising a length, a width, and a thickness, and comprising a material that is electrically superconductive under at least some conditions. In some embodiments, the width of the nanowire is about 50 nm or less, and the nanowire is configured such that a detectable signal can be produced when the nanowire interacts with a single photon and an electrical current is applied through the nanowire.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are schematic illustrations of a nanowire-based optical detector, according to certain embodiments;

FIGS. 1C-1D are, according to some embodiments, top-view schematic illustrations of nanowire layouts;

FIG. 1E is a cross-sectional schematic illustration of a nanowire-based optical detector including an optical cavity, according to some embodiments;

FIG. 2A is a scanning electron microscopy (SEM) image of an exemplary nanowire-based optical detector;

FIG. 2B is a plot of detection efficiency as a function of normalized bias current for the exemplary nanowire-based detector shown in FIG. 2A;

FIG. 2C is a scanning electron microscopy (SEM) image of an exemplary nanowire-based optical detector;

FIG. 2D is a plot of detection efficiency as a function of normalized bias current for the exemplary nanowire-based detector shown in FIG. 2C;

FIG. 3A is a scanning electron microscopy (SEM) image of an exemplary nanowire-based optical detector;

FIG. 3B is a plot of detection efficiency and the photon-induced resistive state formation probability as a function of bias current for the exemplary nanowire-based detector shown in FIG. 3A; and

FIG. 4 is an exemplary plot of absorption as a function of optical cavity thickness, according to one set of embodiments.

### DETAILED DESCRIPTION

Optical detectors and associated systems and methods are generally described. In certain embodiments, the optical detectors comprise nanowire-based optical detectors, which can be used, in certain embodiments, to detect electromagnetic radiation in quantities as small as a single photon. In one aspect, it has been discovered that the geometry of the cross-section of the nanowire employed in a nanowire-based detector can be configured such that overall performance of the detector is enhanced.

It is been recognized, according to one aspect of the invention, that reducing the width of the nanowire within a nanowire-based optical detector can enhance performance (e.g., absorption, detection efficiency) relative to detectors that include relatively wide nanowires. Accordingly, in one aspect, nanowire-based detectors employing relatively narrow nanowires have been developed.

In addition, it is been recognized that, when relatively narrow nanowires within a nanowire-based optical detector are employed, performance of the detector is enhanced when the nanowire thickness is increased. Thus, according to one aspect, detectors comprising nanowires with relatively small widths and large thicknesses have been developed, which are capable of exhibiting enhanced performance relative to other nanowire-based detectors.

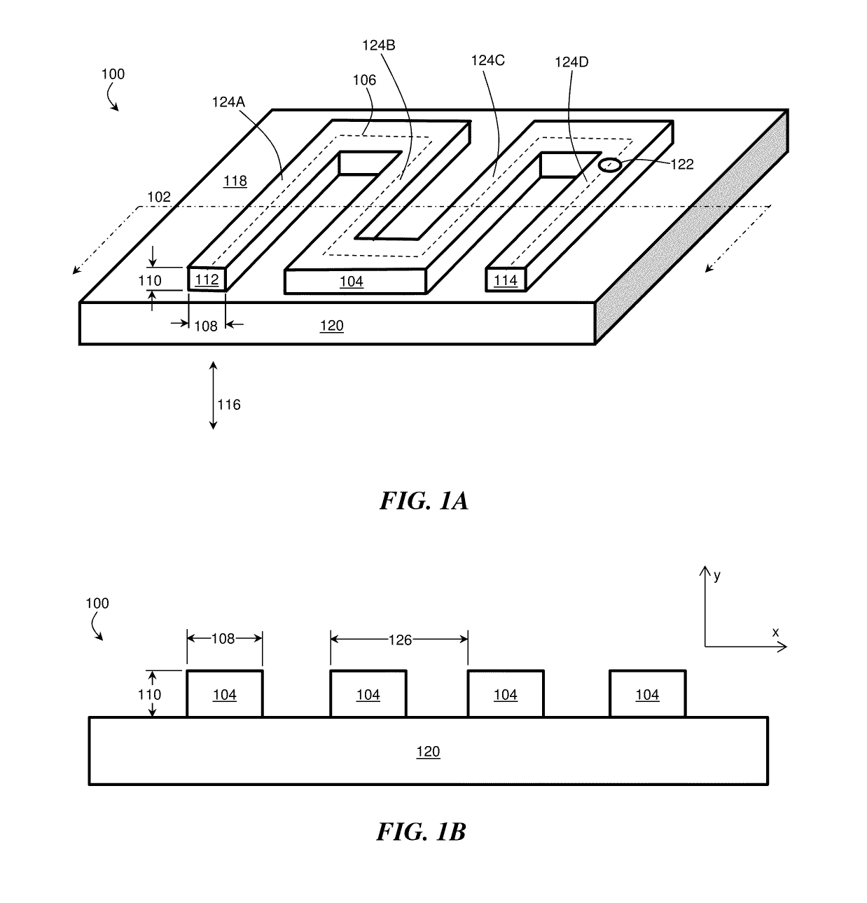

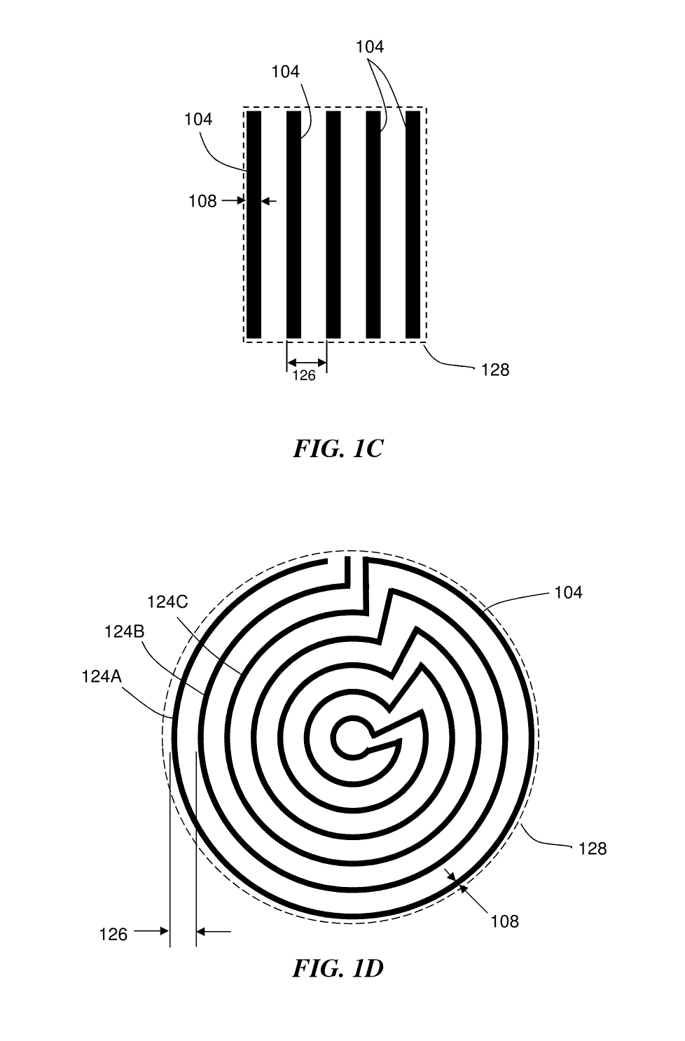

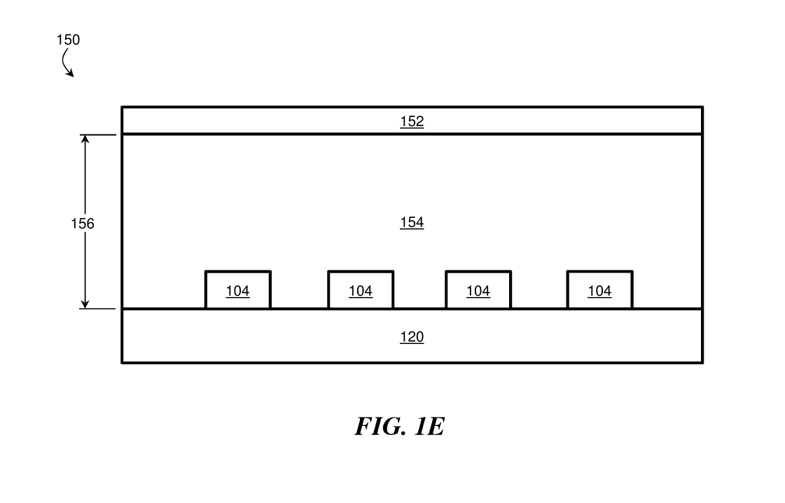

FIGS. 1A-1B are schematic illustrations of optical detector 100, according to certain embodiments. FIG. 1A is a perspective view schematic illustration, while FIG. 1B is a cross-sectional schematic illustration taken across a plane perpendicular to the detector surface and intersecting line 102 of FIG. 1A. Detector 100 comprises nanowire 104 comprising a length, a width, and a thickness. The length of nanowire 104 corresponds to the distance traversed by the pathway indicated by dashed line 106. In FIG. 1A, nanowire 104 has a width 108 and a thickness 110. As described in more detail below, nanowire 104 can comprise a material that is electrically superconductive under at least some conditions.

In certain embodiments, optical detector 100 can be operated as follows. An electrical current can be applied through the length of nanowire 104, for example, by applying a voltage drop across the length of the nanowire. The voltage drop can be applied, for example, by making electrical contact to ends 112 and 114 of the nanowire. Although not illustrated in FIGS. 1A-1B, one of ordinary skill in the art would understand that other components such as electrical contacts could be included in the optical detector. When incoming electromagnetic radiation contacts nanowire 104, the absorption of photons by the nanowire can create a detectable voltage pulse.

As noted above, certain aspects relate to the discovery that the cross-sectional geometry of the nanowire can be tailored to enhance device performance. For example, in certain embodiments, nanowires with relatively small widths can be employed in the optical detectors described herein.

Generally, the width of the nanowire refers to the dimension of the nanowire that is substantially perpendicular to the length of the nanowire and perpendicular to the direction along which the electromagnetic radiation the detector is configured to detect travels. For example, in FIG. 1A, detector 100 is configured to detect electromagnetic radiation traveling in either direction along pathway 116. Accordingly, the width of nanowire 104 at end 112 corresponds to dimension 108, which is perpendicular to direction 116 and perpendicular to length 106 at end 112 (the position at which the width is being determined).

In certain embodiments, the width of the nanowire is aligned in a direction that is substantially parallel to the surface of the substrate on which the nanowire is supported. For example, in FIG. 1A, width 108 is measured along a direction that is substantially parallel to surface 118 of substrate 120 on which nanowire 104 is supported.

In certain embodiments, the nanowire length can extend along two dimensions that establish a surface, and the width of the nanowire is aligned in a direction that is substantially parallel to the surface established by the nanowire. For example, in FIG. 1A, nanowire 104 extends in two-dimensional space along a plane that is substantially parallel to surface 118 of substrate 120, and the width 108 of nanowire 104 extends in a direction substantially parallel to the plane along which the nanowire extends.

In some embodiments, the width of the nanowire could potentially vary along its thickness at a given point along its length (i.e., the width of the nanowire might vary in a direction along the y-axis in FIG. 1B). In such embodiments, the width of the nanowire at a given point would be determined as the largest width of the nanowire along the y-axis at that point along the nanowire's length. In some embodiments, the nanowire can include a relatively consistent width. For example, the width of a nanowire can be within about 20%, within about 10%, within about 5%, or within about 1% of the average width of the nanowire over at least about 50%, at least about 75%, at least about 90%, at least about 95%, or at least about 99% of the length of the longitudinal axis of the nanowire.

As noted above, it has been discovered, within the context of one aspect of the present invention, that optical detectors employing nanowires with relatively small widths (i.e., relatively narrow nanowires) can exhibit enhanced performance. Without wishing to be bound by any particular theory, it is believed that when photons interact with and are absorbed by a nanowire, the photons increase the electrical resistance of the nanowire within a fixed interaction volume that is relatively constant (e.g., having the shape of a cylinder with a diameter of about 30 nm). For example, using FIG. 1A to illustrate, when a single photon interacts with nanowire 104, the volume over which the photon increases the electrical resistance of the nanowire might correspond to the volume below circle 122. It is believed that, when relatively narrow nanowires are employed, individual interactions between single photons and the nanowire produce interaction volumes that occupy a relatively large percentage of the cross-sectional area of the nanowire, relative to the percentage of the cross-sectional area that would have been occupied by the interaction volume in a wider nanowire. It is believed that this can lead to relatively large increases in the resistance of the nanowire when the photon interacts with the nanowire, which can lead to a relatively large detectable signal and enhanced detection efficiency.

In certain embodiments, the width of the nanowire of the optical detector is about 50 nm or less, about 40 nm or less, about 30 nm or less, about 25 nm or less, or about 20 nm or less. In some embodiments, the width of the nanowire can be from about 8 nm to about 50 nm, from about 8 nm to about 40 nm, from about 8 nm to about 30 nm, from about 8 nm to about 25 nm, or from about 8 nm to about 25 nm.

It has also been discovered that, when relatively narrow nanowires are used, increasing the thickness of the nanowire can enhance system performance. Accordingly, in certain embodiments, nanowires with relatively small widths and relatively large thicknesses can be employed in the optical detectors described herein.

Generally, the thickness of the nanowire refers to the dimension of the nanowire that is substantially perpendicular to the length of the nanowire and substantially parallel to the direction along which the electromagnetic radiation the detector is configured to detect travels. For example, detector 100 of FIG. 1A is configured to detect electromagnetic radiation traveling in either direction along pathway 116, and the thickness of nanowire 104 corresponds to dimension 110 at end 112 (which is parallel to direction 116 and perpendicular to length 106 at the position at which the thickness is being determined).

In certain embodiments, the thickness of the nanowire is aligned in a direction that is substantially perpendicular to the surface of the substrate on which the nanowire is supported (and substantially perpendicular to the length of the nanowire). For example, in FIG. 1A, thickness 110 extends along a direction that is substantially perpendicular to surface 118 of the substrate 120 on which nanowire 104 is supported.

In certain embodiments, the length of the nanowire can extend along two dimensions that establish a surface, and the width of the nanowire is aligned in a direction that is substantially parallel to the surface established by the nanowire length (and substantially perpendicular to the length of the nanowire at the measured location). For example, in FIG. 1A, nanowire 104 extends in two-dimensional space along a plane that is substantially parallel to surface 118 of substrate 120, and the thickness 110 of nanowire 104 extends in a direction substantially parallel to the plane along which the nanowire extends.

In some embodiments, the thickness of the nanowire might vary along the width of the nanowire (i.e., along the x-axis in FIG. 1B). In such embodiments, the thickness of the nanowire at a given point would be determined as the largest thickness of the nanowire along the y-axis at that point.

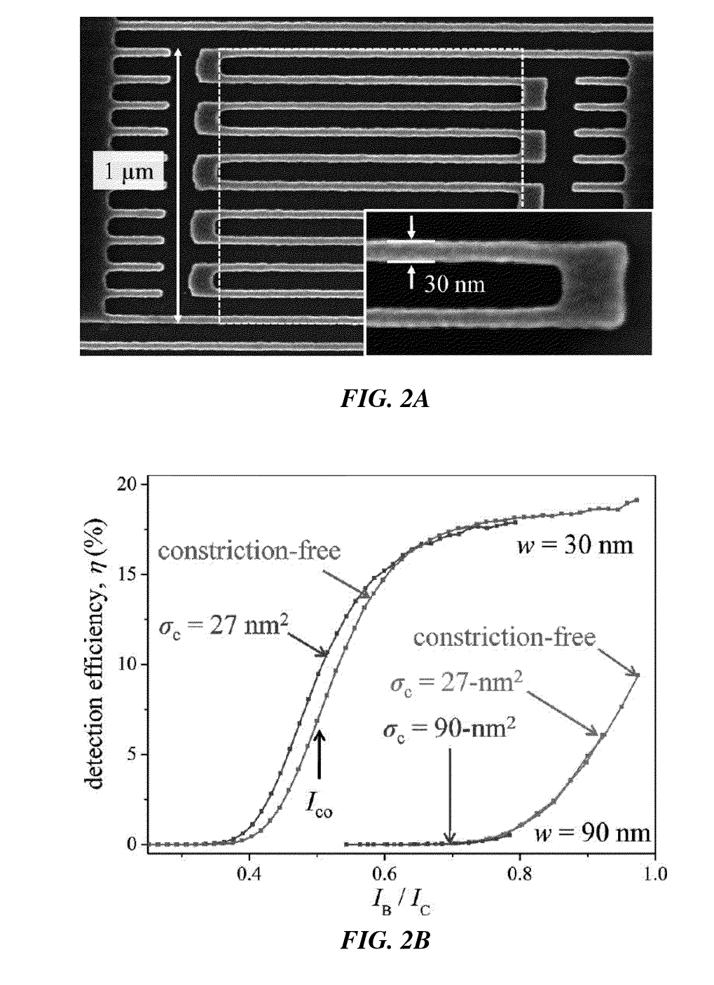

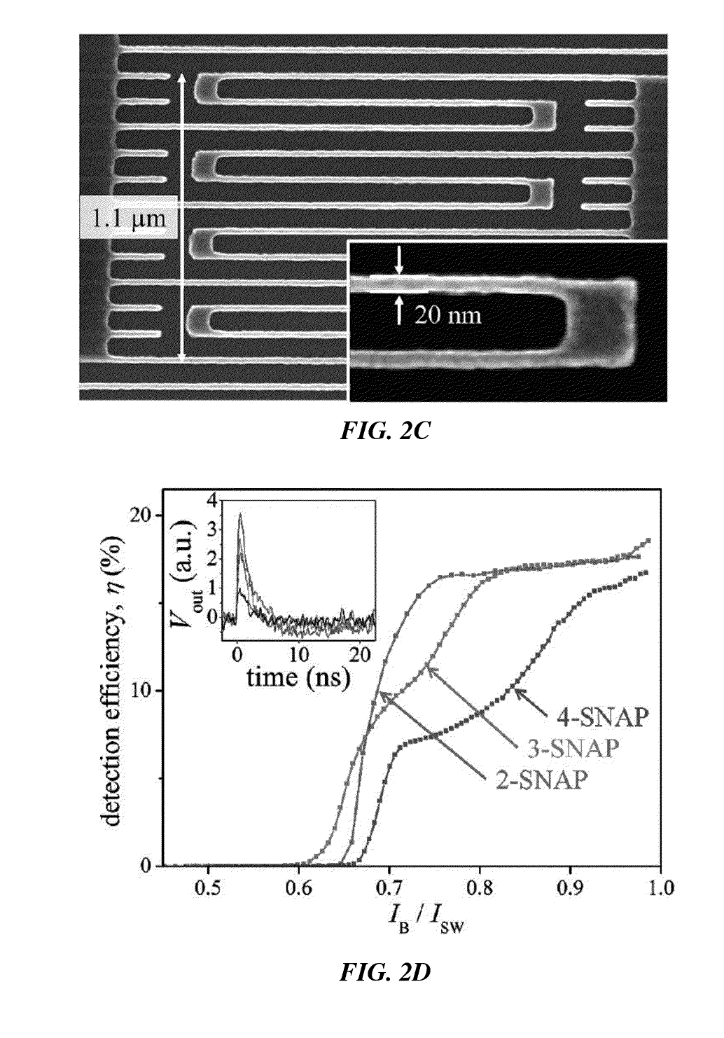

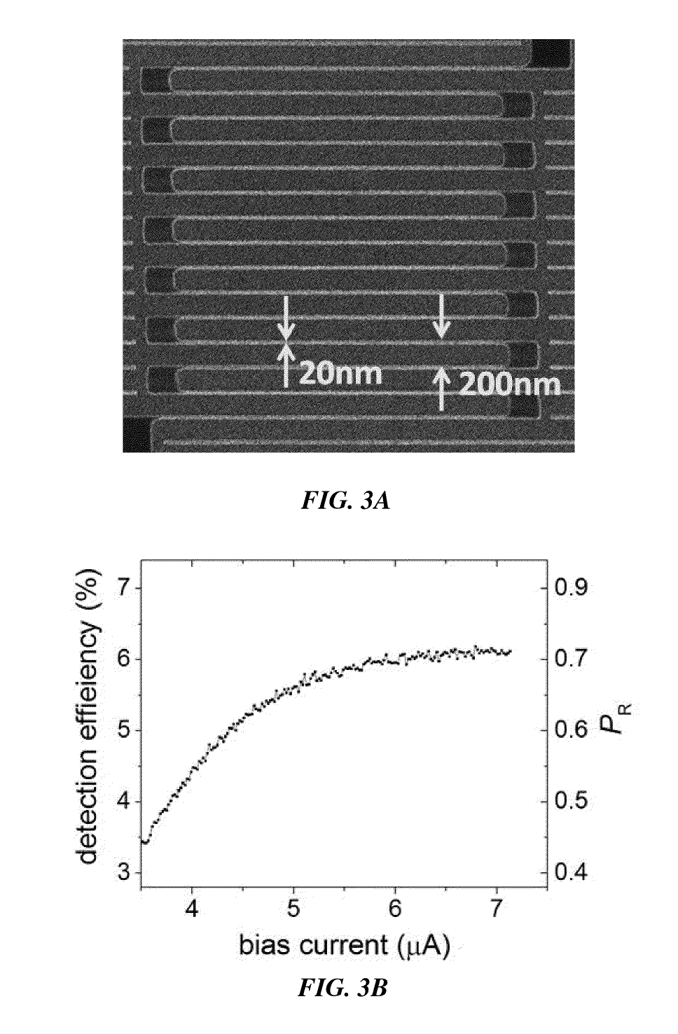

As noted elsewhere, it has been discovered, within the context of one aspect of the present invention, that optical detectors employing nanowires with relatively small widths can exhibit further enhanced performance when the nanowires have relatively large thicknesses. Without wishing to be bound by any particular theory, it was discovered that, in relatively narrow nanowires, the sensitivity of the detector mainly varies with the level of current that can be transported through the nanowire. Because the maximum photodetection signal amplitude of the detector was proportional to (and therefor limited to) the current at which the detector is biased, and this bias current is proportional to the cross sectional area of the nanowires, the use of thicker nanowires are believed to enhance performance of the detectors due to their relatively large cross-sectional areas, through which a relatively large amount of current can be transported. In many previous studies, increases in nanowire thickness have led to decreases in detector efficiency (see, e.g., Annunziata, et al., “Niobium Superconducting Nanowire Single-Photon Detectors,” IEEE Transactions on Applied Superconductivity, 19 (2009) 327 and Hofherr, et al., “Superconducting nanowire single-photon detectors: Quantum efficiency vs. film thickness,” Journal of Physics: Conference Series, 234 (2010) 012017). Accordingly, the positive effects of increases in nanowire thickness were unexpected. It was also discovered that the sensitivity of detectors based on nanowires with relatively narrow widths was not significantly affected by an increase in nanowire thickness. An observed signature of this sensitivity in photon detection was a flat region in the plot of detection efficiency as a function of bias current, where detection efficiency does not significantly vary with bias current. Such behavior can be referred to as “saturation behavior.” This saturation behavior was observed for nanowires with relatively small width and standard thickness (FIG. 2B) and a thickness of about factor two times the standard thickness (FIG. 3B). Detectors comprising relatively thick, narrow nanowires have been found to maintain their sensitivity while producing a relatively large output signal (which can be relatively easy to detect with standard room-temperature electronics), compared to detectors comprising relatively narrow nanowires with smaller thicknesses. The increase in efficiency with increasing nanowire thickness was enhanced in detectors in which a reflective surface was integrated, as described in more detail below.

In certain embodiments, the thickness of the nanowire of the optical detector is about 6 nm or greater, about 7 nm or greater, about 8 nm or greater, or about 10 nm or grater. In some embodiments, the thickness of the nanowire can be from about 6 nm to about 20 nm, from about 7 nm to about 20 nm, from about 8 nm to about 20 nm, from about 9 nm to about 20 nm, or from about 10 nm to about 20 nm.

In certain embodiments, the ratio of the width of the nanowire to the thickness of the nanowire can be about 3 or less, about 2 or less, about 1 or less, about 0.5 or less. In certain embodiments, the ratio of the width of the nanowire to the thickness of the nanowire can be from about 0.4 to about 3, from about 0.4 to about 2, from about 0.4 to about 1, or from about 0.4 to about 0.5.

In certain embodiments, nanowire 104 can comprise a material that is electrically superconductive under at least some conditions. Electrically superconductive materials can be used in nanowire 104, for example, when nanowire 104 is configured to be part of a superconducting nanowire single-photon detectors (SNSPDs). The basic functionality of SNSPDs are described, for example, in “Electrothermal feedback in superconducting nanowire single-photon detectors,” Andrew J. Kerman, Joel K. W. Yang, Richard J. Molnar, Eric A. Dauler, and Karl K. Berggren, Physical Review B 79, 100509 (2009), which is incorporated herein by reference in its entirety for all purposes. Briefly, a plurality of photons can be directed toward a superconducting nanowire (e.g., an niobium nitride (NbN) nanowire) to which a bias current has been applied. A portion of the photons can be absorbed by the nanowire. When an incident photon is absorbed by the nanowire with a bias current slightly below the critical current of the superconducting nanowire, a resistive region called hot-spot is generated, which can yield a detectable voltage pulse. The detectable voltage pulse can serve as an indicator of the presence of a single photon.

Electrically superconductive materials are known to those of ordinary skill in the art, and are generally materials that are capable of conducting electricity in the absence of electrical resistance below a threshold temperature. In some embodiments, nanowire 104 comprises a material that exhibits electrical superconductivity within a range of temperatures from about 1 Kelvin to about 5 Kelvin. In certain embodiments, the material that is electrically superconductive under at least some conditions comprises niobium. For example, the material that is electrically superconductive under at least some conditions comprises, in some embodiments, at least one of NbN, niobium metal, and NbTiN.

In some embodiments, the material that is electrically superconductive under at least some conditions comprises a low-bandgap material. For example, the material that is electrically superconductive under at least some conditions has a bandgap, in some embodiments, of about 10 meV or less or of about 5 meV or less at at least one temperature between 1 Kelvin and 5 Kelvin. In certain embodiments, the material that is electrically superconductive under at least some conditions has a bandgap equal to about 10 meV or less or equal to about 5 meV or less at all temperatures between 1 Kelvin and 5 Kelvin.

Nanowire 104 can be arranged in any suitable fashion. For example, in certain embodiments, the nanowire comprises a plurality of substantially equally spaced elongated portions. For example, in FIGS. 1A-1B, the length 106 of nanowire 104 is arranged such that nanowire 104 forms four elongated portions 124A-124D that are substantially equally spaced. Generally, portions of a nanowire are equally spaced when the largest distance between the plurality of portions is no more than about 10% different than the average of the distances between those portions. In certain embodiments, substantially equally spaced portions can have a largest distance between the plurality of portions that is no more than about 5% different, or no more than 1% different than the average of the distances between those substantially equally-spaced portions. In certain embodiments, the substantially equally-spaced elongated portions can be arranged such that they are approximately parallel to each other (e.g., extending in directions within about 10° of each other, within about 5° of each other, or within 1° of each other). For example, substantially equally-spaced portions 124A-124D in FIGS. 1A-1B are parallel to each other.

The plurality of substantially equally-spaced portions can define a period, in certain embodiments. Generally, the period of substantially-equally spaced portions refers to the average distance between corresponding points of adjacent portions. For example, when the elongated portions comprise substantially parallel portions, the period refers to the average distance between corresponding points of adjacent substantially parallel portions, which is measured as the distance between a point on a first substantially parallel portion of the nanowire to the corresponding point on an adjacent substantially parallel portion of the nanowire. Referring to FIG. 1B, one distance between corresponding points of adjacent substantially parallel portions 124B and 124C corresponds to the distance between the left edges of those substantially parallel portions, as indicated by dimension 126.

In certain embodiments, the period of the elongated portions of the nanowire can be relatively small. For example, in some embodiments, the period of the elongated portions is less than about 5 times the width of the nanowire, less than about 4 times the width of the nanowire, or less than about 3 times the width of the nanowire. In some embodiments, the period of the elongated portions of the nanowire is between about 2 and about 5 times the width of the nanowire, between about 2 and about 4 times the width of the nanowire, or between about 2 times and about 3 times the width of the nanowire.

While FIGS. 1A-1B illustrate one set of embodiments in which a single nanowire is formed in a serpentine pattern, it should be understood that the nanowires described herein can be arranged to form other patterns suitable for use in optical detectors. For example, in certain embodiments, the nanowire can be one of a plurality of nanowires, such as when the detector comprises an array of nanowires. In some embodiments, a plurality of nanowires, not monolithically integrated with each other (i.e., not connected via the same electrically superconductive material during a single formation step), can be formed as a series of substantially parallel nanowires arranged in a side-by-side manner. In such cases, the nanowires can be connected, in series or in parallel, using a different electrically superconductive material (e.g., formed on the substrate), an electrically conductive material (e.g., metals such as gold, silver, aluminum, titanium, or a combination of two or more of these which can be, for example, formed on the substrate), and/or using off-substrate circuitry. In certain embodiments, the array of substantially parallel nanowires can be substantially equally spaced such that they define a period. In cases where multiple substantially parallel nanowires are used, the period of the plurality of nanowires is determined in a similar fashion as described above with relation to the serpentine nanowire. FIG. 1C is a top-view schematic illustration of an array of five nanowires arranged in a side-by-side manner. Similar to the set of embodiments described in FIGS. 1A-1B, the period between adjacent nanowires is indicated by dimension 126.

In still other embodiments, the plurality of elongated, substantially equally spaced portions of electrically superconductive material can include one or more curves. For example, the plurality of elongated, substantially equally spaced portions can be, in certain embodiments, substantially concentric. FIG. 1D is a top-view schematic illustration of one such set of embodiments. In FIG. 1D, portions 124A, 124B, and 124C are substantially equally spaced and define period 126.

In certain embodiments, the detector can comprise a substrate on which the nanowire is supported. For example, in FIGS. 1A-1B, nanowire 104 is supported by substrate 120. In FIGS. 1A-1B, nanowire 104 and substrate 120 are in direct contact. However, in other embodiments, one or more intermediate materials could be positioned between substrate 120 and nanowire 104. In some embodiments, nanowire 104 and substrate 120 are part of a monolithic device in which the nanowire and the substrate cannot be removed from each other without damaging at least one of the nanowire and the substrate. For example, substrate 120 can comprise a growth substrate, in certain embodiments, on which nanowire 104 has been grown (e.g., grown as a film and subsequently patterned to form a nanowire).

Substrate 120 can be, in some embodiments, substantially transparent to at least one wavelength of electromagnetic radiation the detector is configured to detect. Generally, a material is substantially transparent to a given wavelength of electromagnetic radiation if it transmits at least about 90% (or, in certain embodiments, at least about 95%, at least about 98%, at least about 99%, or substantially 100%) of the electromagnetic radiation of the given wavelength that is incident on the material. The use of substantially transparent materials for substrate 120 can be useful in cases in which detector 100 is arranged such that electromagnetic radiation is exposed to the detector from the substrate side. In such cases, the use of a transparent substrate can allow electromagnetic radiation to pass through the substrate to interact with nanowire 104. In certain embodiments, including certain embodiments in which the optical detector is configured to detect infrared radiation, substrate 120 can be substantially transparent to at least one wavelength of infrared electromagnetic radiation (e.g., infrared electromagnetic radiation with a wavelength between about 750 nm and about 10 micrometers).

Substrate 120 can be made of a variety of types of materials. In certain embodiments, substrate 120 comprises at least one of an aluminum oxide (e.g., sapphire), a magnesium oxide (e.g., MgO), a silicon nitride (e.g., Si₃N₄), or silicon. In some embodiments, the portion of substrate 120 over which nanowire 104 is positioned can be made of a single crystal. The use of single crystal substrates can allow for the growth of crystalline nanowire structure (e.g., crystalline NbN, or other crystalline structures).

As noted above, the detectors described herein can be configured such that a detectable signal can be produced when the nanowire interacts with a single photon and an electrical current is applied through the nanowire. A detectable signal refers to any variation in an applied current that can be detected as a voltage pulse, for example, using an oscilloscope or any other tool configured to measure voltage as a function of time. The amplitude of the voltage pulse without further amplification is generally roughly equal to the product of the bias current of the detector times the electrical impedance of the readout electronics, typically 50 Ohms. In certain embodiments, a voltage amplitude having an absolute value of about 75 mV or more can be detected. In some such embodiments, the voltage amplitude of 75 mV or more can be detected after amplification of 10 dB using amplifiers at 25° C. and using counting electronics (e.g., a pulse counter such as an Agilent 53131A pulse counter) at 25° C. In some such embodiments, the 75 mV voltage amplitude is detected while more than 90% of the pulses detected by the counter are either photodetection counts or dark counts caused by the detector, and less than 10% of the detected counts are due to the electrical noise of the room-temperature electronics.

In certain embodiments, the detector is configured such that, when an applied current at at least one level equal to or less than about 6 microAmps is transported through the nanowire, an interaction between the nanowire and a single photon (e.g., a single photon of infrared radiation) produces a detectable change in a signal associated with the applied current. In some such embodiments, the detectable change in the signal can be detected using external electronics (e.g., amplifiers electrically connected to, but thermally separated from the optical detector) when the external electronics are operated at 25° C.

The use of relatively narrow nanowires having relatively small periods can allow one to achieve relatively high single-pass detection efficiencies. The detection efficiency of an optical detector is measured as the percentage of electromagnetic radiation incident on the active area of the detector that is detected by the detector. The active area of the detector refers to the area defined by the outer perimeter of the detector nanowire. For example, in FIG. 1C, the active area of a detector made of nanowires 104 would be bounded by dotted line 128 and would be in substantially the shape of a rectangle. In FIG. 1D, the active area of a detector made of nanowire 104 would be bounded by dotted line 128 and would be in substantially the shape of a circle. Single-pass detection efficiency is used herein to refer to the detection efficiency achieved by the nanowire detector upon a single pass of the photons through the active area defined by the nanowire. Single-pass detection efficiency can be measured by testing the detector in the absence of a reflective surface or other material that redirects electromagnetic radiation back toward the nanowire after that electromagnetic radiation has passed through the nanowire plane a first time. In certain embodiments, the nanowires described herein can achieve single-pass detection efficiencies of from about 15% to about 50%, from about 20% to about 50%, from about 30% to about 50%, or from about 40% to about 50%.

In certain embodiments, a reflective material can be positioned over the nanowire. The reflective material can be positioned such that electromagnetic radiation that does not interact with the nanowire during a first pass through the active area of the nanowire can be reflected back toward the nanowire for detection during a second pass. FIG. 1E is a cross-sectional schematic illustration of detector 150 in which reflective material 152 has been positioned above nanowire 104. As shown in FIG. 1E, reflective material 152 is configured such that nanowire 104 is positioned between the reflective material and substrate 120. Such an arrangement can be used, for example, when the detector is configured to be exposed to electromagnetic radiation from the substrate side of the detector. In other embodiments, reflective material 152 could be positioned on the other side of substrate 120 such that the substrate 120 is positioned between the reflective material and the nanowire.

Reflective material can be selected and configured to reflect at least about 80%, at least about 90%, at least about 95%, at least about 99%, or substantially all of the electromagnetic radiation at the wavelength the detector is configured to detect that is incident on the reflective material. For example, the reflective material can be selected and configured to reflect such that at least about 80% (or at least about 90%, at least about 95%, at least about 99%, or substantially all) of at least one wavelength of infrared radiation that is incident on the reflective material.

Reflective material 152 can be made of a variety of suitable materials. In certain embodiments, reflective material 152 comprises a metal. Exemplary metals suitable for use as reflective material 152 include, but are not limited to, gold, silver, aluminum, platinum, or an alloy thereof, or other combination of these metals.

In some embodiments, a material that is substantially transparent to at least one wavelength the detector is configured to detect is positioned over the nanowire. In FIG. 1E, transparent material 154 is positioned over nanowire 104. Transparent material 154 can be configured such that nanowire 104 is positioned between the substantially transparent material and substrate 120, as illustrated in FIG. 1E. In certain embodiments, substantially transparent material 154 can be selected and configured such that it transmits at least about 90%, at least about 95%, at least about 99%, or substantially all of the electromagnetic radiation the detector is designed to detect.

Substantially transparent material 154 can be made of a variety of suitable materials. In certain embodiments, the substantially transparent material is an electrical insulator. In some embodiments, the substantially transparent material can be made of a photoresist. In some cases, the substantially transparent material can include an inorganic material (e.g., an inorganic photoresist). The substantially transparent material comprises, in some embodiments, hydrogen silsesquioxane, poly(methyl methacrylate), ZEP 520A, or any other negative high-resolution photoresist. In some embodiments, the first electrically insulating material can comprise an evaporated or sputtered silicon oxide. Electrically insulating material 154 could also comprise a metal oxide, such as titanium oxide. Generally, the type of material selected as transparent material 154 will be dependent upon the wavelength the detector is designed to detect. One of ordinary skill in the art, given the present disclosure, would be capable of selecting a suitable transparent material for a given set of design specifications.

In certain embodiments, reflective material 152 can be separated from substrate 120 by a distance 156 that is selected to enhance the degree to which photons are absorbed by the optical detector. Not wishing to be bound by any particular theory, it is believed that, when the distance between reflective material 152 and substrate 120 is close to one-quarter of the wavelength of electromagnetic radiation the detector is configured to detect, the electromagnetic radiation field near the nanowire (i.e., at the field anti-node created by the quarter-wave resonator) is enhanced, and absorbance of photons is increased. In such cases, the presence of the reflective surface over the nanowire can be said to create optical resonance in the detector. In certain embodiments, the distance between reflective material 152 and substrate 120 is from 0.1λ to about 0.4λ, from 0.2λ to about 0.3λ, from about 0.23λ to about 0.27λ, or from about 0.24λ to about 0.26λ, wherein λ is at least one wavelength of electromagnetic radiation the detector is configured to detect.

It has unexpectedly been discovered that the enhancement of performance achieved via the use of relatively thick nanowires is further enhanced when optical resonance structures (such as the structure illustrated in FIG. 1E) are made part of the optical detector. Not wishing to be bound by any particular theory, it is believed that, in systems in which optical resonance structures are employed, thick nanowires occupy a large amount of the volume between the substrate and the reflective surface, relative to the amount of the volume between the substrate and the reflective surface that would be occupied by a thin nanowire. This allows photons that are reflected by the reflective surface a greater opportunity to interact with the nanowire (and thus be detected), thereby enhancing detection efficiency. Accordingly, in certain embodiments, the optical detectors described herein can achieve detection efficiencies of at least about 90%, at least about 95%, or at least about 99% (and, in certain embodiments, up to substantially 100%).

The systems, articles, and methods described herein can be used in a variety of applications, for example, to produce highly sensitive photon counters. Such counters can be useful in the production of cryptographic devices (e.g., fiber-based quantum key distribution systems), photon counting optical communication systems, and the like. In some cases, the systems, articles, and methods can be used to produce or as part of a linear optical quantum computer. The detectors described herein can also be used in the evaluation of transistor elements in large-scale integrated circuits, as the elements emit photons; characterization of the photons and their time of arrival can be used to understand the operation of the circuit, for example. The embodiments described herein may also find use in underwater communications, inter-planetary communications, or any communication system in which ultra-long-range or absorbing or scattering media produce relatively high link losses.

In certain embodiments, the optical detectors described herein can be tailored to detect particular wavelengths or ranges of wavelengths. For example, in some cases, the optical detector can be configured to detect at least one wavelength of infrared electromagnetic radiation, as measured in a vacuum (e.g., at least one wavelength of infrared electromagnetic radiation with a wavelength between about 750 nm and about 10 micrometers, as measured in a vacuum). In some cases, the optical detector can be constructed and arranged to detect visible light (i.e., wavelengths of between about 380 nm and about 750 nm, as measured in a vacuum). In some cases, the optical detector can be constructed and arranged such that, during operation, it can be tuned to detect a predetermined range of wavelengths of electromagnetic radiation (e.g., a range with a width of less than about 1000 nm, less than about 100 nm, less than about 10 nm, between about 0.1 nm and about 1000 nm, between about 0.1 nm and about 100 nm, between about 0.1 nm and about 10 nm, or between about 0.1 nm and about 1 nm, each range as measured in a vacuum). The optical detectors described herein can be used to detect single photons of electromagnetic radiation having a wavelength in any of these ranges.

The nanowire-based detectors described herein can be fabricated using many traditional micro- and nanofabrication techniques. According to one exemplary technique, the nanowire material is formed over a substrate. The nanowire material can be formed, for example, using a thin film deposition process, such as sputter deposition, electron-beam deposition, chemical vapor deposition, or a variety of other suitable methods.

In embodiments in which NbN is used as a nanowire material, the ability to use relatively thick films of NbN to form the nanowire is advantageous because thick NbN films (e.g., films 6 nm in thickness and thicker) are substantially easier to grow than thin NbN films (e.g., films less than 6 nm in thickness). Thick NbN films can be grown at room temperature, as opposed to the higher temperatures necessary to produce thin NbN films.

After the nanowire material film has been formed, the desired nanowire geometry can be formed by forming an etch mask over the nanowire material, removing the etch mask material over the portions of the nanowire material that are to be removed (i.e., such that the etch mask material covers the nanowire material that will form the nanowire) and subsequently removing the nanowire material under the exposed nanowire material surface.

In one set of embodiments, closely-spaced, high aspect ratio features can be formed within the nanowire material by exposing the mask material to an electron beam after it has been patterned. Such exposures can increase the resistance of the mask material to the nanowire material etchant, which can allow one to use relatively thin mask materials to pattern deep features in the nanowire material. For example, in cases where a hydrogen silsesquioxane (HSQ) mask is used in a CF₄-based etching step, exposure of the HSQ to a high current, low-voltage e-beam can increase the HSQ's resistance to CF₄. The use of thin mask materials can be desirable, for example, in many cases in which the mask is developed using electron beams. In such cases, when thick mask materials are developed, the electron beams scatter as they pass through the mask material, which can cause the exposed features to be relatively large at the interface between the mask and the nanowire material, relative to their size at the exposed mask material surface. Increasing the thickness of the mask material increases the degree to which electron scattering occurs. Accordingly, by using relatively thin mask materials, one can develop a pattern in the mask material in which the pattern at the mask/nanowire material interface is close to or the same as the pattern on the exposed surface of the mask material.

After the nanowire material has been patterned, the etch mask material can be removed (if desired) from over the nanowire material using a suitable solvent, or any other suitable method.

One of ordinary skill in the art would understand how to connect the devices described herein to external devices (e.g., an RF coaxial readout, a lens coupled fiber, etc.) for use in practice. For example, electrical contacts can be made to the electrically superconductive material (e.g., the electrically superconductive nanowire) by fabricating electrically conductive contact pads connected to the ends of the electrically superconductive material. In some embodiments, the optical detectors described herein can be constructed and arranged to be used at very low temperatures (e.g., less than about 10 K, less than about 5 K, or less than about 3 K). One of ordinary skill in the art would be capable of designing the systems and articles described herein such that stable electrical communication could be made at these very low temperatures. Such methods are described, for example, in “Efficiently Coupling Light to Superconducting Nanowire Single-Photon Detectors,” Xiaolong Hu, Charles W. Holzwarth, Daniele Masciarelli, Eric A. Dauler, and Karl K. Berggren, IEEE Transactions on Applied Superconductivity 19, pp. 336-340 (2009).

The terms “electrically insulating material” and “electrically conductive material” would be understood by those of ordinary skill in the art. In addition, one of ordinary skill in the art, given the present disclosure, would be capable of selecting materials that fall within these categories while providing the necessary function to produce the devices and performances described herein. For example, one of ordinary skill in the art would be capable of selecting a material that would be capable of providing proper electrical insulation between an electrically superconductive material and a relatively electrically conducting material in order to, for example, prevent electron transfer between those two materials. In some embodiments, an electrically conductive material can have an electrical resistivity of less than about 10⁻³ ohm·cm at 20° C. The electrically insulating material can have, in some instances, an electrical resistivity of greater than about 10⁸ ohm·cm at 20° C.

The following examples are intended to illustrate certain embodiments of the present invention, but do not exemplify the full scope of the invention.

### EXAMPLE 1

This example describes the fabrication and testing of a niobium nitride (NbN) nanowire-based optical detector using a narrow (20 and 30 nm width), relatively thin (about 4 to 4.5 nm) nanowire.

5.5-nm-thick NbN films (estimated from the deposition time) were deposited by current-controlled DC reactive magnetron sputtering 1 of Nb in Ar and N₂ plasma on R-plane sapphire substrates at a temperature of about 900° C. Accounting for a 1-1.5-nm-thick surface oxide (measured on similar films with a transmission electron microscope) we estimated the thickness of the superconducting film to be about 4 to 4.5 nm. The superconducting critical temperature of these films was T_{C}=10.8 K (measured at the midpoint of the transition).

Ultranarrow-nanowire superconducting nanowire single-photon detectors (SNSPDs) were fabricated on these films using a hydrogen silsesquioxane (HSQ) mask. The HSQ layer was spin coated to a thickness of 45 nm, and exposed using an electron beam. After the exposure step, the samples were developed in 25% tetramethylammonium hydroxide (TMAH) at 24° C. for 4 minutes. For comparison purposes, 90-nm-wide nanowire-based SNSPDs were fabricated on a 5-nm-thick NbN film with T_{C}=9-10 K. FIG. 2A is a scanning electron microscopy (SEM) image of an SNSPD nanowire with a width of 30 nm and a pitch of 100 nm.

The SNSPDs were tested in a cryogenic probe station at a temperature of about 4.7 K. The SNSPDs were illuminated through the back of the substrate by using a high-numerical-aperture single-mode fiber (NA=0.2), mounted inside the chamber on a micromanipulator arm. Electrical contact was made with a cryogenic RF microprobe connected to a cryogenic coaxial cable (bandwidth 40 GHz), which was mounted on a second micromanipulator arm. Both the probe and fiber arms were anchored to the radiation shield, held at a temperature of 20 K. The devices were current-biased with a low-noise voltage source in series with a 100-kω resistor through the dc port of a room-temperature bias-tee (40 dB isolation; 100 KHz-4 GHz bandwidth on the RF port). The read-out circuit consisted of a chain of two or three low-noise room-temperature amplifiers (20 MHz-3 GHz bandwidth; 20 dB gain; 2.5 dB noise figure) connected to the RF port of the bias-tee. The amplified signal was fed to a 225-MHz-bandwidth counter (for detection efficiency measurements), to a 6-GHz-bandwidth, 40 Gsample/s oscilloscope (for jitter measurements) or to a 2 GHz-bandwidth, 10 Gsample/s oscilloscope (for inter-arrival time measurements). The light source used for the detection efficiency measurements was a pulsed gain-switched laser diode emitting at 1550 nm. The pulse width was 15 ns, and the repetition rate was 50 MHz. The polarization of the light was controlled with a fiber-coupled polarization controller.

FIG. 2B is a plot of device detection efficiency at λ=1550 nm as a function of normalized bias current (I_{B}/I_{C}, where I_{B} is the bias current and I_{C} is the nanowire critical current). Nanowires with constrictions and nanowires without constrictions were tested. The device constriction state was quantified by estimating the area of the non-superconducting part of the nanowire cross section as σ_{c}=σₙ(1−I_{SW}/I_{C}), where σₙ is the nominal nanowire cross section (estimated from the nanowire width, measured by SEM, and the nanowire thickness, estimated from the material deposition time and rate), I_{SW} is the device switching current (defined as the bias current at which the device switches from the superconducting to the normal state), and I_{C} is the device critical current (experimentally defined as the highest measured I_{SW} of the devices fabricated on the same film for the ultranarrow-nanowire SNSPDs (I_{C}=7.2 μA) and extracted from kinetic inductance vs IB measurements for the 90 nm nanowire-width SNSPDs (I_{C}=18.8-20.1 μA) fabricated in Kerman, A. J. et al., “Constriction limited detection efficiency of superconducting nanowire single-photon detectors, Appl. Phys. Lett. 2007, 90 (10), 101110). The device detection efficiency was calculated as:

η=H(CR−DCR)/Nₚₕ

where CR is the count rate measured when the SNSPD was illuminated, DCR is the count rate measured when the SNSPD was not illuminated, H is a normalization factor, and Nₚₕ is the number of photons per second incident on the device active area. The normalization factor, H, was used to account for photon counts that originated outside the active area shown in white dotted lines in FIG. 2A, and was calculated as the ratio between the nanowire length within the active area, and the total length of 30 nm wide nanowire (i.e., including length portions outside the white dotted line area).

As can be seen from FIG. 2B, the detection efficiencies of both the non-constricted and constricted 30-nm-wide nanowire based detectors were substantially higher than those of the 90-nm-wide nanowire based detectors, especially at low bias currents.

Nanowire detectors employing 20-nm wide nanowires were also used in superconducting nanowire avalanche photon (SNAP) detectors. An exemplary SNAP detector employing four 20-nm-wide nanowires (i.e., a 4-SNAP detector) is shown in the SEM image of FIG. 2C. FIG. 2D is a plot of detection efficiency as a function of the normalized bias current applied to the detectors. Each of the 2-SNAP, 3-SNAP, and 4-SNAP detectors tested exhibited relatively high efficiencies. The inset of FIG. 2D is a plot of output voltage as a function of time for the 2-SNAP, 3-SNAP, and 4-SNAP detectors. The 4-SNAP detectors exhibited the largest voltage pulse, while the 2-SNAP detectors exhibited the smallest voltage pulse. This result is important in that it demonstrates that detectable signals can be generated in detectors employing nanowires as narrow as 20 nm. As illustrated below in Examples 2 and 3, further improvements can be achieved with the thickness of the nanowire is increased.

### EXAMPLE 2

This example describes the fabrication and testing of a niobium nitride (NbN) nanowire-based optical detector using a narrow (about 20 nm), relatively thick (about 9.7 nm) nanowire.

A 9.7-nm-thick NbN films was grown on a Si₃N₄ substrate using an AJA sputtering system. The sputter deposition time was 2 minutes, and the current setpoint was 400 mA. The NbN film was grown at room temperature (i.e., about 25° C.). The NbN films had a sheet resistance of about 330Ω.

After the NbN film was grown, a hydrogen silsesquioxane (HSQ) film with a thickness of about 60-nm was spin coated onto the NbN film. The nanowire pattern in the HSQ was formed by exposing the HSQ to an electron beam at 30 keV and exposing the HSQ for 3 minutes in room-temperature tetramethylammonium hydroxide (TMAH). Subsequently, the developed pattern was e-beam flood-exposed at 30 mC/cm² (using a 10 keV acceleration voltage) to increase the resistance of the HSQ during the NbN etching step. Finally, the pattern in the HSQ was transferred into the NbN film via a CF₄-based deep reactive ion etch step. The resulting NbN nanowire had a thickness of about 9.7 nm, a consistent width of about 20 nm, and a pitch of about 200 nm. FIG. 3A is a scanning electron microscopy (SEM) image of the resulting nanowire detector.

The detector shown in FIG. 3A was cooled to a temperature of about 1.5 Kelvin and was front-illuminated with 1550-nm-wavelength electromagnetic radiation, polarized parallel to the parallel nanowire segments. FIG. 3B is a plot of detection efficiency (left-hand y-axis) and the photon-induced resistive state formation probability of the nanowire (P_{R}, right-hand y-axis) as a function of bias current for the detector shown in FIG. 3A. The device detection efficiency was calculated as:

η=(CR−DCR)/Nₚₕ

where CR is the count rate measured when the SNSPD was illuminated and DCR is the count rate measured when the SNSPD was not illuminated. P_{R} was calculated as

P_{R}=η/A

where η is the detection efficiency and A is the calculated optical absorption of the detector.

The devices were current-biased with a low-noise voltage source in series with a 100-kΩ resistor through the dc port of a room-temperature bias-tee (40 dB isolation; 100 KHz-4 GHz bandwidth on the RF port). The read-out circuit included a chain of three low-noise room-temperature amplifiers (20 MHz-3 GHz bandwidth; 20 dB gain; 2.5 dB noise figure) connected to the RF port of the bias-tee. The amplified signal was fed to a 225-MHz-bandwidth counter for detection efficiency measurements.

The light source used for the detection efficiency measurements was a CW laser diode emitting at 1550 nm or a pulsed gain-switched laser diode emitting at 1550 nm (pulse width 5 ns, repetition rate 2.5-40 MHz). The polarization of the light was controlled with a fiber-coupled polarization controller.

A flat “saturation regime” was observed at higher bias current values. This saturation behavior was a strong indication of the high internal detection efficiency (P_{R}) of these detectors. As shown in FIG. 3B this prototype reached a P_{R} value of greater than 70%, despite the fact that the NbN films were grown at room temperature and had a critical temperature (T_{c}) (i.e., the temperature at which the nanowire material changes from superconductive to resistive) of 8-9 Kelvin. It is believed that, if NbN films grown at higher temperatures are used, reach higher P_{R} values (perhaps as high as 90%) can be reached.

It is also noteworthy that, because of the relatively large signal amplitude of the photodetection signal produced by this nanowire, room-temperature electronics (e.g., amplifiers) could be used to read out the photodetection signal over the entire range over which the detection efficiency shows saturation behavior. It is believed that the larger signal amplitude was due to the larger thickness (about 10 nm) of the 20-nm wide nanowire, relative to the thinner (about 4 nm) 20-nm wide nanowire detector described in Example 1. Also, latching was not observed in this detector, despite the fact that the kinetic inductance of this SNSPD is expected to be more than twice as high as an SNSPD based on 4-nm-thick, 20-nm-wide nanowires of equivalent active area and nanowire length.

### EXAMPLE 3

This example describes the simulation of an ultranarrow, thick nanowire-based detector including a quarter-wavelength optical cavity. The configuration of the detector used in in this simulation was similar to that shown in FIG. 1E The detector geometry in this simulation included a nanowire with a width of 20 nm and a thickness of 10 nm. The pitch of the substantially parallel portions of the nanowire was set at 40 nm such that nanowire material occupied about 50% of the active area of the detector.

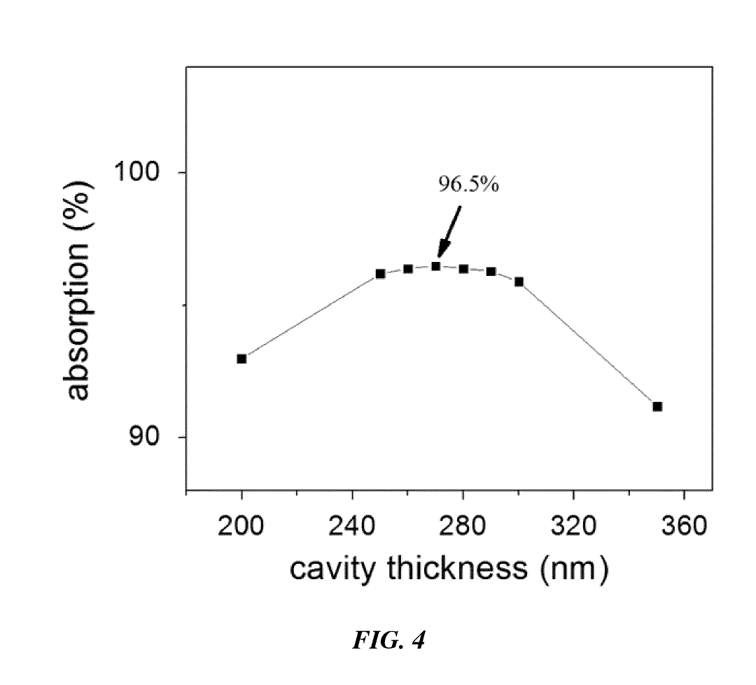

Simulated optical absorption at 1550 nm wavelength was performed for this detector using Comsol Multiphysics RF module. The distance between the substrate and the reflective layer was varied to determine the optimal cavity thickness. As shown in FIG. 4, it was demonstrated that the optimal cavity thickness for this detector was 270 nm, at which an absorption of 96.5% was achieved. As described in Example 2, detectors have been fabricated with P_{R} values exceeding 70%. Based on the results shown in FIG. 4, it is believed that nanowire detectors such as those tested in Example 2 would achieve an efficiency (which can be calculated by multiplying the absorption by P_{R}) of about 69% (i.e., E=A*P_{R}=96.5%*0.71=69%). It is believed that, if a niobium nitride film grown at a higher growth temperature were used to form the detector discussed in Example 2, P_{R} values in excess of 0.9 could be achieved. This would lead to detection efficiencies in excess of 90%, when integrated with an optical cavity.

The fabrication process to make a detector such as the detector illustrated in FIG. 1E would be relatively simple, compared to other fabrication processes used to make previous nanowire-based detectors. For example, because nano-antennae would not be used, there would be no difficult alignment steps that would need to be performed and device yields would be increased. In addition, the design illustrated in FIG. 1E poses little constraint on the accuracy of cavity thickness, with interval variations of up to about 40 nm being acceptable. Finally, proximity effects during the e-beam lithography step would be minimal because the nanowire would only occupy about 50% of the active area of the detector.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An optical detector, comprising:
a nanowire comprising a length, a width, and a thickness, and comprising a material that is electrically superconductive under at least some conditions, wherein:
the width of the nanowire is about 50 nm or less, and
the nanowire is configured such that a detectable signal can be produced when the nanowire interacts with a single photon and an electrical current is applied through the nanowire.

2. The optical detector of claim 1, comprising a substrate on which the nanowire is supported.

3. The optical detector of claim 1, wherein the thickness of the nanowire is about 6 nm or greater.

4. The optical detector of claim 1, wherein the thickness of the nanowire is from about 6 nm to about 20 nm.

5-6. (canceled)

7. The optical detector of claim 1, wherein the width of the nanowire is from about 8 nm to about 50 nm.

8. (canceled)

9. The optical detector of claim 1, wherein the ratio of the width of the nanowire to the thickness of the nanowire is about 3 or less.

10. (canceled)

11. The optical detector of claim 1, wherein the nanowire comprises a plurality of substantially equally spaced elongated portions defining a period, and the period is equal to or less than about 5 times the width of the nanowire.

12-14. (canceled)

15. The optical detector of claim 1, wherein the detector is configured to detect at least one wavelength of infrared electromagnetic radiation, as measured in a vacuum.

16. The optical detector of claim 1, wherein the material that is electrically superconductive under at least some conditions comprises niobium.

17. The optical detector of claim 1, wherein the material that is electrically superconductive under at least some conditions comprises at least one of NbN, niobium metal, and NbTiN.

18. The optical detector of claim 1, comprising a reflective material positioned over the nanowire, wherein the reflective material is configured to reflect at least about 80% of electromagnetic radiation at the wavelength the detector is configured to detect that is incident on the reflective material.

19. The optical detector of claim 18, wherein the detector comprises a substrate, and the nanowire is positioned between the reflective material and the substrate.

20. The optical detector of claim 18, wherein the reflective material is configured to reflect at least about 80% of at least one wavelength of infrared radiation that is incident on the reflective material.

21-22. (canceled)

23. The optical detector of claim 2, wherein the nanowire is in direct contact with the substrate.

24. The optical detector of claim 1, comprising a material that is substantially transparent to at least one wavelength the detector is configured to detect positioned over the nanowire

25. The optical detector of claim 24, wherein the detector comprises a substrate, and the nanowire is positioned between the substantially transparent material and the substrate.

26-27. (canceled)

28. The optical detector of claim 1, wherein the detector is configured such that, when an applied current at at least one level equal to or less than about 6 microAmps is transported through the nanowire, an interaction between the nanowire and a single photon produces a detectable change in a signal associated with the applied current.

29. The optical detector of claim 1, wherein the detector is configured such that, when an applied current of 6 microAmps is transported through the nanowire, an interaction between the nanowire and a single photon can be detected using external electronics when the external electronics are operated at 25° C.

30. The optical detector of claim 2, wherein the substrate is substantially transparent to at least one wavelength of electromagnetic radiation the detector is configured to detect.

31-32. (canceled)

33. The optical detector of claim 1, wherein the material that is electrically superconductive under at least some conditions has a bandgap of about 10 meV or less at at least one temperature from about 1 Kelvin to about 5 Kelvin.
